(19) United States
(12) Patent Application Publication
(10) Pub. No.: US 2022/0278317 A1
(43) Pub. Date: Sep. 1, 2022

(54) Rechargeable Alloy Battery for Electric Vehicles

(71) Applicant: Nissan North America, Inc., Franklin, TN (US)

(72) Inventor: Mohammed Hussain Abdul Jabbar, Farmington Hills, MI (US)

(73) Assignee: Nissan North America, Inc., Franklin, TN (US)

(21) Appl. No.: 17/186,264

(22) Filed: Feb. 26, 2021

(51) Int. Cl. H01M 4/38; H01M 10/0562; H01M 10/0585; H01M 4/36; H01M 10/052

(52) U.S. Cl. CPC H01M 4/382; H01M 10/0562; H01M 10/0585; H01M 4/38; H01M 4/364; H01M 10/052; H01M 2004/021

(57) ABSTRACT

An electrochemical cell includes an anode comprising a first anode metal, an anode current collector, a cathode comprising a first cathode metal, a cathode current collector, and an electrolyte layer between the anode and the cathode. The electrolyte layer comprises a mesoporous material of polymer or glass and a salt electrolyte filling pores of the mesoporous material, wherein the pores are interconnected and the salt electrolyte is a salt of the first anode metal.

### TECHNICAL FIELD

This disclosure relates to rechargeable alloy batteries for electric vehicles.

### BACKGROUND

The use of lithium ion batteries has been increasing for a wide variety of applications, including electric vehicles, due in part to their high energy densities and low maintenance requirements. However, lithium ion batteries are costly to manufacture. Certain safety concerns are associated with lithium ion batteries as well. New battery chemistries that are lower in cost and overcome the safety issues are needed to replace lithium ion batteries, while achieving the performance of lithium ion batteries.

### SUMMARY

Disclosed herein are implementations of rechargeable alloy batteries for electric vehicles, and in particular, electrochemical cells, a plurality of which form the rechargeable alloy batteries.

One implementation of an electrochemical cell disclosed herein includes an anode comprising a first anode metal, an anode current collector, a cathode comprising a first cathode metal, a cathode current collector, and an electrolyte layer between the anode and the cathode. The electrolyte layer comprises a mesoporous material of polymer or glass and a salt electrolyte filling pores of the mesoporous material, wherein the pores are interconnected and the salt electrolyte is a salt of the first anode metal.

Another implementation of an electrochemical cell disclosed herein includes an anode comprising a first anode metal and a second anode metal, an anode current collector, a cathode comprising a first cathode metal and a second cathode metal, a cathode current collector, and an electrolyte layer between the anode and the cathode. The electrolyte layer can include a mesoporous material of polymer or glass and a salt electrolyte filling pores of the mesoporous material, wherein the pores are interconnected and the salt electrolyte is a salt of the first anode metal. In implementations, the first anode metal can have a melting point of 100° C. or less and the second anode metal can have a melting point of 400° C. or greater. In implementations, the electrochemical cell can have an operating temperature of less than 300° C. and the first cathode metal and the first anode metal can be selected to be in liquid form during operation of the electrochemical cell while the second cathode metal and the second anode metal can be selected to be solid during operation of the electrochemical cell.

Implementations disclosed herein can further include and electrolyte layer further comprising a framework of insulating polymer extending between the anode and the cathode, the framework defining hollow columns extending from the anode and the cathode, wherein each hollow column is filled with the mesoporous material with the salt electrolyte filling the pores of the mesoporous material.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-sectional view of an implementation of an electrochemical cell as disclosed herein, with an enlarged view of the electrolyte layer.

FIG. 2 is a cross-sectional view of another implementation of an electrochemical cell as disclosed herein.

FIG. 3 is a plan view of a framework for an electrolyte layer for an electrochemical cell as disclosed herein.

FIG. 4 is a cross-sectional view of another implantation of an electrochemical cell as disclosed herein, which an enlarged view of the electrolyte layer.

### DETAILED DESCRIPTION

The use of lithium ion batteries has been increasing for a wide variety of applications, including electric vehicles, due in part to their high energy densities and low maintenance requirements. However, lithium ion batteries are costly to manufacture. Certain safety concerns are associated with lithium ion batteries as well. New battery chemistries that are lower in cost and that overcome the safety issues are needed to replace lithium ion batteries, while achieving or exceeding the performance of lithium ion batteries.

Battery chemistries such as metal alloys that are used in stationary applications have been considered as the materials are more cost effective and safer than those used in lithium ion batteries. However, some stationary battery chemistries require batteries that are large and heavy due to the amount of material required. Some stationary battery chemistries also operate at high temperatures, operating at or higher than about 600° C. The large footprint, weight and operating temperatures of these stationary batteries prohibits their use in electronic vehicles.

Disclosed herein are electrochemical cells, and batteries comprising multiple electrochemical cells, of a metal solid state design that are stackable, use available, lower-cost materials, and are safe to operate. The electrochemical cells and batteries comprising the electrochemical cells are rechargeable and meet performance, size and weight requirements for use in electric vehicles.

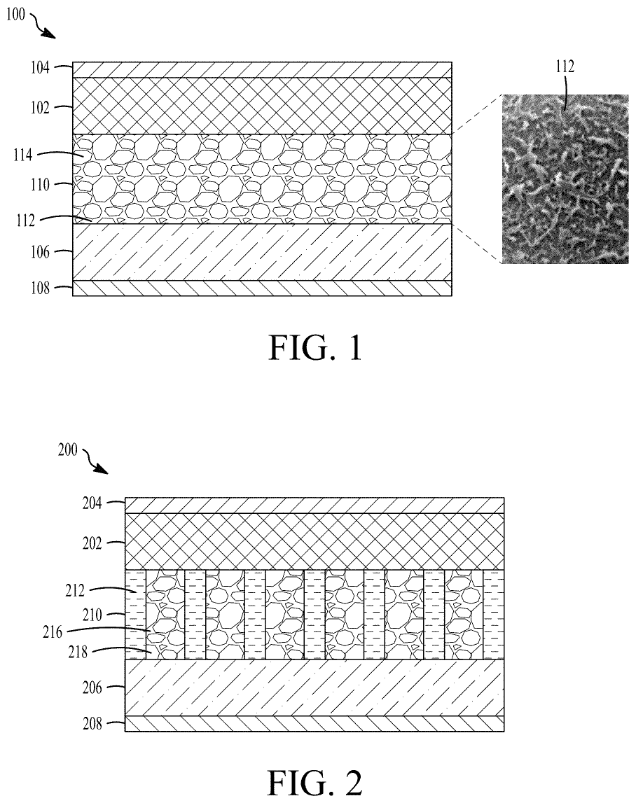

In an implementation of an electrochemical cell 100 disclosed herein and illustrated in FIG. 1, there is an anode 102 comprising an anode metal, an anode current collector 104, a cathode 106 comprising a cathode metal, a cathode current collector 108, and an electrolyte layer 110 between the anode 102 and the cathode 106. The electrolyte layer 110 comprises a mesoporous material 112 of polymer or glass and a salt electrolyte 114 filling pores of the mesoporous material 112. The pores of the mesoporous material 112 are interconnected and the salt electrolyte 114 is a salt of the first anode metal.

The mesoporous material 112 of polymer or glass has a porosity of between about 40% and 70%, inclusive, and retains the salt electrolyte 114 in the pores. The pores of the mesoporous material 112, seen in the enlarged portion of FIG. 1, are interconnected, creating pathways of electrolyte through the electrolyte layer 110 between the anode 102 and the cathode 106. The salt electrolyte 114 is selected based on the anode metal. For example, if the anode metal is lithium, the salt electrolyte 114 is lithium chloride.

The anode metal of anode 102 is selected from the group consisting of lithium, sodium, potassium, rubidium, caesium, magnesium, calcium, strontium, and barium. The anode current collector 104 can be, for example, copper. The cathode metal of cathode 106 is selected from the group consisting of aluminum, gallium, indium, titanium, zinc, cadmium, mercury, tin, lead, antimony, bismuth, and tellurium. The cathode current collector 108 can be, for example, aluminum.

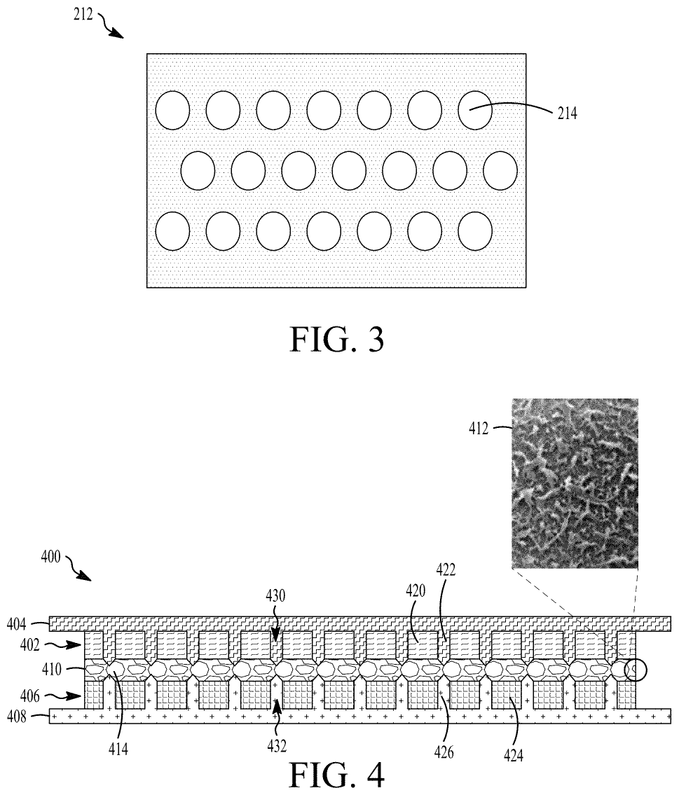

In another implementation of an electrochemical cell 200 disclosed herein and illustrated in FIG. 2, the electrolyte layer 110 of FIG. 1 is modified to include structural support. In the electrochemical cell 200 in FIG. 2, there is an anode 202 comprising an anode metal, an anode current collector 204, a cathode 206 comprising a cathode metal, a cathode current collector 208, and an electrolyte layer 210 between the anode 202 and the cathode 206. The electrolyte layer 210 comprises a framework 212 of insulating polymer extending between the anode 202 and the cathode 206. The framework 212, seen in plan view in FIG. 3, defines hollow columns 214 extending from the anode 202 and the cathode 206. Each hollow column 214 is filled with mesoporous material 216, with salt electrolyte 218 filling the pores of the mesoporous material 216. The framework 212 is made of an insulating polymer such as polytetrafluoroethylene. The framework 212 provides additional mechanical structural strength to the electrochemical cell 200 during operation as the anode metal and cathode metal are in a molten state during operation. The total volume of the hollow columns 214 should be as large as possible while maintaining structural strength of the framework 212 surrounding hollow columns 214.

The mesoporous material 216 is polymer or glass, the polymer being the same or different than that of the framework 212. The mesoporous material 216 of polymer or glass has a porosity of between about 40% and 70%, inclusive, and retains the salt electrolyte 218 in the pores. The pores of the mesoporous material 216, seen in the enlarged portion of FIG. 1, are interconnected, creating pathways of electrolyte through the electrolyte layer 210 between the anode 202 and the cathode 206. The salt electrolyte 218 is selected based on the anode metal. For example, if the anode metal is lithium, the salt electrolyte 218 is lithium chloride.

The anode metal of anode 202 is selected from the group consisting of lithium, sodium, potassium, rubidium, caesium, magnesium, calcium, strontium, and barium. The anode current collector 204 can be, for example, copper. The cathode metal of cathode 206 is selected from the group consisting of aluminum, gallium, indium, titanium, zinc, cadmium, mercury, tin, lead, antimony, bismuth, and tellurium. The cathode current collector 208 can be, for example, aluminum. In a non-limiting example, the anode metal is lithium, the cathode metal is gallium, and the salt electrolyte is lithium chloride.

Another implementation of an electrochemical cell 300 is described with respect to FIG. 4. The electrochemical cell 400 has the same electrolyte layer 110 as that with respect to electrochemical cell 100, with structural support added to the anode and cathode as described herein. The electrochemical cell 400 comprises an anode 402 comprising a first anode metal 420 and a second anode metal 422, an anode current collector 404, a cathode 406 comprising a first cathode metal 424 and a second cathode metal 426, a cathode current collector 408, and an electrolyte layer 410 between the anode 402 and the cathode 406. The electrolyte layer 410 comprises a mesoporous material 412 of polymer or glass and a salt electrolyte 414 filling pores of the mesoporous material 412, wherein the pores are interconnected and the salt electrolyte 414 is a salt of the first anode metal 420.

The mesoporous material 412 of polymer or glass has a porosity of between about 40% and 70%, inclusive, and retains the salt electrolyte 414 in the pores. The pores of the mesoporous material 412, seen in the enlarged portion of FIG. 4, are interconnected, creating pathways of electrolyte through the electrolyte layer 410 between the anode 402 and the cathode 406. The salt electrolyte 414 is selected based on the first anode metal 420. For example, if the first anode metal 420 is lithium, the salt electrolyte 414 is lithium chloride.

In the electrochemical cell 400, the second anode metal 422 and the anode current collector 204 are of the same metal and the first anode metal 420 has a lower melting point than the second anode metal 422. The second anode metal 422 is formed in isolated columns 430 extending between the anode current collector 404 and the electrolyte layer 410. The term “isolated columns 430” as used herein means the columns are isolated from each other and each is surrounded by the first anode metal 420. The electrochemical cell 400 has an operating temperature of less than about 300° C., typically between about 30° C. and 300° C. The first cathode metal 424 and the first anode metal 420 are selected to be in liquid form during operation of the electrochemical cell 400 while the second cathode metal 426 and the second anode metal 422 are selected to be solid during operation of the electrochemical cell 400. The isolated columns 430 of the second anode material 422 provide structural support to the anode during operation, when the first anode material 420 is molten. The isolated columns 430 in total are between about 20% and 30% volume of the anode 402, with the first anode metal 420 being between about 70% and 80% volume of the anode 402. The isolated columns 430 can be uniformly spaced along the anode 402 as illustrated or can be non-uniformly spaced, so long as the requisite structural support to the anode 402 is provided. The isolated columns 430 can be round or can be in other shapes. The isolated columns 430 can also be walls that extend along a dimension of the anode 402.

In the electrochemical cell 400, the second cathode metal 426 and the cathode current collector 208 are of the same metal and the first cathode metal 424 has a lower melting point than the second cathode metal 426. The second cathode metal 426 is formed in isolated columns 432 extending between the cathode current collector 408 and the electrolyte layer 410. The term “isolated columns 432” as used herein means the columns are isolated from each other and each is surrounded by the first cathode metal 424. The electrochemical cell 400 has an operating temperature of less than about 300° C., typically between about 30° C. and 300° C. The first cathode metal 424 and the first anode metal 420 are selected to be in liquid form during operation of the electrochemical cell 400 while the second cathode metal 426 and the second anode metal 422 are selected to be solid during operation of the electrochemical cell 400. The isolated columns 432 of the second cathode material 426 provide structural support to the cathode during operation, when the first cathode material 424 is molten. The isolated columns 432 in total are between about 20% and 30% volume of the cathode 406, with the first cathode metal 424 being between about 70% and 80% volume of the cathode 406. The isolated columns 432 can be uniformly spaced along the cathode 406 as illustrated or can be non-uniformly spaced, so long as the requisite structural support to the cathode 406 is provided. The isolated columns 432 can be round or can be in other shapes. The isolated columns 432 can also be walls that extend along a dimension of the cathode 406.

The isolated columns 430 of the anode 402 and the isolated columns 432 of the cathode 406 can extend to and/or slightly into the electrolyte layer 410. The isolated columns 430 of the anode 402 and the isolated columns 432 of the cathode 406 can be formed to prevent the respective molten first anode metal 420 and first cathode metal 424 from flowing during operation, acting as channels to the electrolyte layer 410. The isolated columns 432 of the cathode 406 and the isolated columns 430 of the anode 402 can be aligned from one another on opposing sides of the electrolyte layer 410 as illustrated in FIG. 4. This structure reduces the ohmic resistance of the electrolyte layer 410.

During operation of the electrochemical cell 400, the isolated columns 430 of the anode 402 and the isolated columns 432 of the cathode 406 can extend into the electrolyte layer 110, an example of which is shown in FIG. 4. During operation of the electrochemical cell 400, the first anode metal 420 will vary in volume during charge/discharge and the first cathode metal 424 will include vary in volume during charge/discharge as a liquid alloy is formed of the first cathode metal 424 and the first anode metal 420 in the cathode 406. Having the isolated columns 430, 432 extend slightly into the electrolyte layer 410 can account for these volume changes, keeping the structural integrity of the electrochemical cell 400 and continuing to reduce the ohmic resistance of the electrolyte layer 410. The isolated columns 430, 432 can be formed on the respective current collector with any known deposition method, including 3D printing. The second anode metal 422 and second cathode metal 426 can be deposited to have a conical end as illustrated in FIG. 4, or the ends of the isolated columns 430, 432 can be flat or rounded, as non-limiting examples.

The second cathode metal 426 and the cathode current collector 408 can be aluminum, as a non-limiting example. The first cathode metal 424 is selected from the group consisting of aluminum, gallium, indium, titanium, zinc, cadmium, mercury, tin, lead, antimony, bismuth, and tellurium. The second anode metal 422 and the anode current collector 404 can be copper, as a non-limiting example. The first anode metal 420 is selected from the group consisting of lithium, sodium, potassium, rubidium, caesium, magnesium, calcium, strontium, and barium. As a non-limiting example, the first anode metal 420 can be lithium and the first cathode material 424 can be gallium, with the salt electrolyte 414 being lithium chloride.

The electrochemical cells disclosed herein can be stacked to form a battery or battery pack. The electrochemical cells can be stacked such that adjacent electrochemical cells share a common current collector. As one example, a second electrochemical cell can be stacked on a first electrochemical cell such that the anode current collector is shared between anodes of the first and second electrochemical cell, and a third electrochemical cell can be stacked on the second electrochemical cell such that the cathode current collector is shared between cathodes of the second and third electrochemical cells.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An electrochemical cell, comprising:
an anode comprising a first anode metal;
an anode current collector;
a cathode comprising a first cathode metal;
a cathode current collector; and
an electrolyte layer between the anode and the cathode, the electrolyte layer comprising:
a mesoporous material of polymer or glass; and
a salt electrolyte filling pores of the mesoporous material, wherein the pores are interconnected and the salt electrolyte is a salt of the first anode metal.

2. The electrochemical cell of claim 1, wherein the mesoporous material has a porosity of between 40% and 70%, inclusive.

3. The electrochemical cell of claim 1, wherein the electrolyte layer further comprises:
a framework of insulating polymer extending between the anode and the cathode, the framework defining hollow columns extending from the anode and the cathode, wherein each hollow column is filled with the mesoporous material with the salt electrolyte filling the pores of the mesoporous material.

4. The electrochemical cell of claim 3, wherein the first anode metal is lithium, the first cathode metal is gallium, and the salt electrolyte is lithium chloride.

5. The electrochemical cell of claim 1, wherein the anode further comprises:
a second anode metal, wherein
the second anode metal and the anode current collector are of the same metal;
the first anode metal has a lower melting point than the second anode metal; and
the second anode metal is formed in isolated columns extending between the anode current collector and the electrolyte layer.

6. The electrochemical cell of claim 5, wherein the first anode metal has a melting point of 100° C. or less and the second anode metal has a melting point of 400° C. or greater.

7. The electrochemical cell of claim 5, wherein the isolated columns in total are between about 20% and 30% volume of the anode.

8. The electrochemical cell of claim 5, wherein the second anode metal is copper and the first anode metal is selected from the group consisting of lithium, sodium, potassium, rubidium, caesium, magnesium, calcium, strontium, and barium.

9. The electrochemical cell of claim 5, wherein the cathode further comprises:
a second cathode metal, wherein
the second cathode metal and the cathode current collector are of the same metal;
the first cathode metal has a lower melting point than the second cathode metal; and
the second cathode metal is formed in isolated columns extending between the cathode current collector and the electrolyte layer.

10. The electrochemical cell of claim 9, wherein the first cathode metal has a melting point of 100° C. or less and the second cathode metal has a melting point of 400° C. or greater.

11. The electrochemical cell of claim 9, wherein the isolated columns in total are between about 20% and 30% volume of the cathode.

12. The electrochemical cell of claim 9, wherein the second cathode metal is aluminum and the first cathode metal is selected from the group consisting of aluminum, gallium, indium, titanium, zinc, cadmium, mercury, tin, lead, antimony, bismuth, and tellurium.

13. The electrochemical cell of claim 9, wherein the isolated columns of the cathode and the isolated columns of the anode are aligned from one another on opposing sides of the electrolyte layer.

14. The electrochemical cell of claim 9, wherein the first anode metal is lithium, the second anode metal is copper, the first cathode metal is gallium, the second cathode metal is aluminum and the salt electrolyte is lithium chloride.

15. An electrochemical cell, comprising:
an anode comprising a first anode metal and a second anode metal;
an anode current collector;
a cathode comprising a first cathode metal and a second cathode metal;
a cathode current collector; and
an electrolyte layer between the anode and the cathode, the electrolyte layer comprising:
a mesoporous material of polymer or glass; and
a salt electrolyte filling pores of the mesoporous material, wherein the pores are interconnected and the salt electrolyte is a salt of the first anode metal.

16. The electrochemical cell of claim 15, wherein:
the second anode metal and the anode current collector are of the same metal;
the first anode metal has a lower melting point than the second anode metal;
the second anode metal is formed in isolated columns extending between the anode current collector and the electrolyte layer;
the second cathode metal and the cathode current collector are of the same metal;
the first cathode metal has a lower melting point than the second cathode metal; and
the second cathode metal is formed in isolated columns extending between the cathode current collector and the electrolyte layer.

17. The electrochemical cell of claim 16, wherein the first cathode metal has a melting point of 100° C. or less and the second cathode metal has a melting point of 400° C. or greater, and the first anode metal has a melting point of 100° C. or less and the second anode metal has a melting point of 400° C. or greater.

18. The electrochemical cell of claim 16, having an operating temperature of less than 300° C. and the first cathode metal and the first anode metal are selected to be in liquid form during operation of the electrochemical cell while the second cathode metal and the second anode metal are selected to be solid during operation of the electrochemical cell.

19. The electrochemical cell of claim 16, wherein the isolated columns of the anode in total are between about 20% and 30% volume of the anode, and the isolated columns of the cathode in total are between about 20% and 30% volume of the cathode.

20. The electrochemical cell of claim 16, wherein the second cathode metal is aluminum and the first cathode metal is selected from the group consisting of aluminum, gallium, indium, titanium, zinc, cadmium, mercury, tin, lead, antimony, bismuth, and tellurium, and the second anode metal is copper and the first anode metal is selected from the group consisting of lithium, sodium, potassium, rubidium, caesium, magnesium, calcium, strontium, and barium.
